(19) United States
(12) Patent Application Publication
(10) Pub. No.: US 2015/0353357 A1
(43) Pub. Date: Dec. 10, 2015

(54) APPARATUS, SYSTEM, AND METHOD FOR CONVERTING A FIRST SUBSTANCE INTO A SECOND SUBSTANCE

(71) Applicants: Abbas Hassan, Sugar Land, TX (US); Aziz Hassan, Sugar Land, TX (US); Rayford G. Anthony, College Station, TX (US); Alishah Hassan, Sugar Land, TX (US)

(72) Inventors: Abbas Hassan, Sugar Land, TX (US); Aziz Hassan, Sugar Land, TX (US); Rayford G. Anthony, College Station, TX (US); Alishah Hassan, Sugar Land, TX (US)

(73) Assignee: H R D Corporation, Sugar Land, TX (US)

(21) Appl. No.: 14/816,840

(22) Filed: Aug. 3, 2015

Related U.S. Application Data
(62) Division of application No. 13/847,355, filed on Mar. 19, 2013, now abandoned.
(60) Provisional application No. 61/613,760, filed on Mar. 21, 2012.

(51) Int. Cl. C01B 23/00

(52) U.S. Cl. CPC C01B 23/00

(57) ABSTRACT

A system for converting a first substance into a second substance, the system including a mixing reactor configured to provide a reactant mixture comprising a first reactant, a second reactant, and a solvent; and a high shear device fluidly connected to the mixing reactor, wherein the high shear device comprises at least one rotor/stator set comprising a rotor and a complementarily-shaped stator symmetrically positioned about an axis of rotation and separated by a shear gap, wherein the shear gap is in the range of from about 10 microns to about 250 microns; and a motor configured for rotating the rotor about the axis of rotation, whereby energy can be transferred from the rotor to the reactants thereby inducing reactions between the first reactant and the second reactant to form a product.

### CROSS-REFERENCE TO RELATED APPLICATIONS

This application is a divisional application of U.S. application Ser. No. 13/847,355, filed on Mar. 19, 2013, which claims benefit of U.S. Provisional Application Ser. No. 61/613,760 filed on Mar. 21, 2012. The disclosures of said applications are incorporated herein by reference in their entirety for all purposes.

### STATEMENT REGARDING FEDERALLY SPONSORED RESEARCH OR DEVELOPMENT

Not Applicable.

### BACKGROUND OF THE INVENTION

1. Technical Field

The present invention generally relates to breaking and creating bonds between subatomic and/or atomic particles. More specifically, in embodiments, the present invention relates to adding subatomic particles to, removing subatomic particles from, and/or changing subatomic particles in the nucleus of atoms. More specifically, in embodiments, the present invention relates to adding and/or removing protons and/or neutrons from a nucleus and/or converting a proton into a neutron and/or converting a neutron into a proton. Even more specifically, in embodiments, the present invention relates to obtaining helium-3 from helium-4. Even more specifically, in embodiments, the present invention relates converting one element or isotope into another element or isotope.

2. Background of the Invention

Helium-3 is a light, non-radioactive isotope of helium with two protons and one neutron. For example, Helium-3 has a number of uses in both research and industry. Helium-3 is used in cryogenics to achieve temperatures on the order of a few tenths of a Kelvin and in combination with helium-4 in a dilution refrigerator to achieve temperatures as low as a few thousandths of a Kelvin. Helium-3 is also an important isotope in instrumentation for neutron detection. Other uses of helium-3 include medical imaging. Helium-3 is also used for some fusion processes.

Although there are many uses for helium-3, the abundance of helium-3 on earth is quite rare. In fact, helium, although common throughout the universe, is quite rare on earth. Furthermore, not only is helium quite rare on earth, but the proportion of helium that is helium-3 is quite low. For example, the helium-3 content of near-surface atmospheric air is 7.27±0.20 parts per trillion by volume (pptv) and the helium-3/helium-4 ratio for atmospheric helium is approximately 1.393×10⁻⁶. The ratio from any earth source is not greater than about 5 parts helium-3 to a million parts of helium-4. Thus, obtaining significant amounts of helium-3 from naturally occurring sources is difficult.

Helium-3 may also be obtained as the product of tritium (a radioactive isotope of hydrogen containing two neutrons and one proton) decay. This is currently the most common commercial method of obtaining helium-3. Because tritium is radioactive, it is potentially dangerous if inhaled or ingested. Furthermore, tritium can combine with oxygen to form tritiated water molecules that can be absorbed through the pores in the skin. In addition to being dangerous, tritium is also rare. Tritium is typically produced in nuclear reactors by neutron activation of lithium-6. This method is expensive, however, and can render reactor components radioactive.

Other elements are similarly rare and difficult to obtain. More specifically rare earth elements such as Lanthanides, that are finding increased utility as more applications are commercialized, are difficult to obtain in nature. For example, rare earth elements are used in liquid-crystal displays for computer monitors and televisions, fiber optic cables, magnets, glass polishing, DVDs, USB drives in computers, catalytic converters, petroleum cracking catalysts, batteries, fluorescent lights, missiles, jet engines, and satellites.

Accordingly, in view of the art, there is a need for an efficient and economical system, apparatus and method for obtaining helium-3 and other rare elements from cheaper, more abundant elements. Furthermore, there is a need for a system, apparatus, and method of obtaining helium-3 that is safer and results in less radioactive byproducts than current methods provide. Additionally, there is a need for an efficient and economical system for obtaining rare earth elements from cheaper and more abundant elements. There is also a need for an economical method for converting an isotope of an element into another isotope or element.

### SUMMARY

Herein disclosed are a high shear system and process that promote neutron stripping and atomic rearrangement that can result in changes in atomic number and/or changes in isotope formation for a given element. The high shear device induces localized high pressures and high temperatures that enable nucleon-nucleon interactions resulting in nucleus rearrangement. In particular, mechanical energy from the rotors and stators of the high shear device is imparted to the nucleus of an element. In embodiments, the mechanical energy is transferred via inorganic particles such as metals (e.g., silver). The resultant energy transfer can result in highly localized areas of high pressure and high temperature sufficient to overcome the coulomb barrier and allow nucleon-nucleon interactions between the various element nuclei.

In an embodiment, a high shear system and process for converting helium-4 into helium-3 is disclosed. The high shear device induces localized high pressures and high temperatures that enable nucleon-nucleon interactions resulting in hydrogen and helium-4 interacting to generate helium-3. In particular, mechanical energy from the rotors and stators of the high shear device are imparted to the hydrogen and helium through inorganic particles such as metals (e.g., silver). The resultant energy transfer can result in highly localized areas of high pressure and high temperature sufficient to overcome the coulomb barrier and allow nucleon-nucleon interactions between or among the nuclei of the various elements (e.g., between hydrogen and helium nuclei).

In an embodiment of this disclosure, a process employs a high shear mechanical reactor to provide enhanced pressure and temperature reaction conditions that promote the conversion of helium-4 to helium-3. Furthermore, a process disclosed in an embodiment described herein comprises dissolving helium-3 in ammonium hydroxide solution for long term storage of helium-3.

In an embodiment of this disclosure, a system for converting a first substance into a second substance is provided. The system includes a mixing reactor agitating a mixture in order to provide reactants, wherein the mixture comprises a first reactant and a second reactant combined with a solvent, and optionally particles of a solid suspended and/or dissolved in the solvent. The system also includes a high shear device fluidly connected to the mixing reactor, wherein the high shear device comprises at least one stage. At least one stage of the high shear device includes a rotor symmetrically positioned about an axis of rotation and surrounding an interior space. The stage of the high shear device also includes an outer casing, wherein the outer casing and the rotor are separated by an annular space, wherein the distance between the rotor and the outer casing is greater than approximately 10 microns and is less than or equal to approximately 250 microns. The high shear device also includes a motor configured for rotating the rotor about the axis of rotation, wherein energy from rotating the rotor is transferred from the rotor to the reactant, optionally via solid particles, thereby inducing reactions between the first reactant and the second reactant to form a product.

In an embodiment of this disclosure, a system for converting helium-4 into helium-3 is provided. The system includes a mixing reactor configured to agitate a mixture in order to provide reactants, wherein the mixture comprises hydrogen, helium, and a solvent, and optionally particles of an inorganic solid, which may be suspended in the solvent. The system also includes a high shear device fluidly connected to the mixing reactor. The high shear device includes a rotor symmetrically positioned about an axis of rotation and surrounding an interior space; an outer casing, wherein the outer casing and the rotor are separated by an annular space, wherein the distance between the rotor and the outer casing is greater than or equal to approximately 250 microns; a motor configured for rotating the rotor about the axis of rotation, wherein energy from rotating the rotor is transferred from the rotor to the hydrogen and helium, optionally aided by the presence of inorganic solid particles, thereby inducing localized areas of high pressure and high temperature promoting the interaction of hydrogen and helium nuclei such that some of the helium-4 in the helium is converted to helium-3; a feed inlet configured to receive the reactants from the mixing reactor, said feed inlet positioned along the axis of rotation and fluidly connected with the interior space and with a first outlet of the mixing reactor; and a first outlet, wherein the first outlet is fluidly connected with the interior space and with a recycle inlet of the mixing reactor to provide the mixing reactor with a product mixture comprising converted helium-3 dissolved in the solvent. The system also includes a separation unit for separating at least a portion of the helium-3 from the solvent, wherein the separation unit comprises an inlet fluidly connected with a second outlet of the mixing reactor and a sampling outlet for obtaining the helium-3.

In an embodiment of this disclosure, a method for long term storage of helium-3 is provided. The method includes obtaining helium-3, mixing the helium-3 with ammonium hydroxide solution under pressure such that the helium-3 is dissolved in the ammonium hydroxide solution, and maintaining the pressure on the helium-3 dissolved in the ammonium hydroxide.

In an embodiment described in the present disclosure, a method of converting helium-4 into helium-3 is provided. The method may include combining hydrogen, helium, and a solvent and optionally suspending and/or dissolving metal particles in the solvent to form a feed stream and introducing the feed stream into an interior space of a high shear device, the interior space containing at least one rotor and at least one complementarily-shaped stator separated by a gap in the range of from about 10 microns to about 250 microns and symmetrically positioned about an axis of rotation. The method further includes rotating the at least one rotor about the axis of rotation, whereby mechanical energy is transferred from the rotating rotor to the nuclei of the hydrogen and helium thereby inducing localized areas of high pressure and high temperature promoting nuclear reactions resulting in the conversion of at least some of the helium-4 into helium-3. The method further comprises extracting a product stream from the interior space, wherein the product stream helium-3 converted from the helium-4, and may further comprise one or more of unreacted hydrogen, unreacted helium, and solid particles.

In an embodiment of this disclosure, a method for converting a first element into a different element or into an isotope of the first element is provided. The method may comprise providing a feed stream or emulsion comprising hydrogen, the first element and a solvent. The method may further include introducing the feed stream into an interior space of a high shear device, the interior space containing at least one rotor and at least one complementarily-shaped stator separated by a gap between the rotor and a stator and symmetrically positioned about an axis of rotation, and rotating the at least one rotor about the axis of rotation, whereby mechanical energy is transferred from the rotating rotor to the individual nuclei thereby inducing localized areas of high pressure and high temperature promoting nuclear reactions between individual nuclei of the element and the hydrogen nuclei resulting in the conversion of at least some of the first element into the different element or the isotope of the first element. The method may further comprise extracting a product stream from the high shear device, wherein the product stream comprises the different element or the isotope of the first element. Providing the feed stream may further comprise dissolving hydrogen in the solvent via a mixing reactor and the method may further comprise recycling the product stream to the mixing reactor and extracting at least a portion of the product stream from the mixing reactor into a separation unit whereby at least a portion of the different element or the isotope of the first element may be separated from at least a portion of the solvent. The solvent may be selected from the group consisting of ammonium hydroxide solutions, water, oils, and combinations thereof. In embodiments, the feed stream further comprises solids. In embodiments, the solid particles are selected from the group consisting of metals, ceramics, metal oxides, and combinations thereof. In embodiments, the solid comprises metal particles. The solid may comprise particles having an average size in the range of from about two microns to about eight microns. Rotating the rotor about the axis of rotation may produce a shear rate greater than about 100,000,000 s⁻¹. In embodiments, the shear gap is greater than about 250 microns. In embodiments, the shear gap is less than about 250 microns.

In embodiments of the method, the first element is selected from the group consisting of rare earth elements and the different element is a higher order rare earth element. In embodiments, the first element is a radionuclide. In embodiments, the first element is selected from the group consisting of radionuclides of cesium and strontium and the isotope of the first element is selected from the group consisting of stable isotopes of the first element. In embodiments, the first element is selected from the group consisting of strontium-89, strontium-90, and combinations thereof. The isotope of the first element may be selected from the group consisting of strontium-84, strontium-86, strontium-87, strontium-88, and combinations thereof. The isotope of the first element may comprise primarily strontium-88. In embodiments, the first element is selected from the group consisting of cesium-129, cesium-131, cesium-132, cesium-134, cesium-135, cesium-136, cesium-137, and combinations thereof. In embodiments, the first element is selected from the group consisting of cesium-134, cesium-135, cesium-137, and combinations thereof. The isotope of the first element may comprise cesium-133.

The feed stream may comprise a contaminated fluid containing the first element, solid particles, water, and oil. The solid particles may comprise sand. The method may further comprise introducing an oxygen scavenger into the feed stream. In embodiments, the oxygen scavenger comprises hydrazine.

These and other embodiments and potential advantages will be apparent in the following detailed description and drawings.

### BRIEF DESCRIPTION OF THE DRAWINGS

For a more detailed description of the preferred embodiment of the present invention, reference will now be made to the accompanying drawings, wherein:

FIG. 1A is a schematic of a system for converting helium-4 into helium-3 according to an embodiment of this disclosure.

FIG. 1B is a schematic of a system for converting helium-4 into helium-3 according to an embodiment of this disclosure.

FIG. 1C is a schematic of a system for converting helium-4 into helium-3 according to an embodiment of this disclosure.

FIG. 2A is a schematic of a system for converting one isotope or element into a different isotope or element according to an embodiment of this disclosure.

FIG. 2B is a schematic of a system for converting one isotope or element into a different isotope or element according to an embodiment of this disclosure.

FIG. 2C is a schematic of a system for converting one isotope or element into a different isotope or element according to an embodiment of this disclosure.

FIG. 3 is a schematic of a high shear device according to an embodiment of this disclosure.

FIG. 4 is a table illustrating exemplary test results of converting helium-4 to helium-3.

### NOTATION AND NOMENCLATURE

As used herein, the use of the term “hydrogen” refers to all isotopes and forms of hydrogen unless indicated otherwise explicitly or by context. As used herein, the use of the terms “hydrogen-1,” “protium,” “light hydrogen,” “H-1,” “¹H” all refer to the single proton isotope of hydrogen unless indicated otherwise explicitly or by context. As used herein, the terms “deuterium,” “hydrogen-2,” “²H,” “H-2,” and “D” all refer to the isotope of hydrogen having one neutron unless indicated otherwise explicitly or by context. As used herein, the use of the terms “tritium,” “hydrogen-3,” “³H,” “H-3,” and “T” all refer to the isotope of hydrogen having two neutrons unless indicated otherwise explicitly or by context. As used herein, the use of the term “helium” refers to all isotopes and forms of helium unless indicated otherwise explicitly or by context. As used herein, the use of the terms “helium-3,” “³He,” and “He-3” all refer to the isotope of helium having one neutron unless indicated otherwise explicitly or by context. As used herein, the use of the terms “helium-4,” “⁴He,” and “He-4” refer to the isotope of helium having two neutrons unless indicated otherwise explicitly or by context.

As used herein, the use of the terms “yttrium” and “Y” refer to all isotopes and forms of yttrium unless indicated otherwise explicitly or by context. As used herein, the use of the terms “scandium” and “Sc” refer to all isotopes and forms of scandium unless indicated otherwise explicitly or by context. As used herein, the use of the terms “cerium” and “Ce” refer to all isotopes and forms of cerium unless indicated otherwise explicitly or by context. As used herein, the use of the terms “lanthanum” and “La” refer to all isotopes and forms of lanthanum unless indicated otherwise explicitly or by context. As used herein, the use of the terms “praseodymium” and “Pr” refer to all isotopes and forms of praseodymium unless indicated otherwise explicitly or by context. As used herein, the use of the terms “neodymium” and “Nd” refer to all isotopes and forms of neodymium unless indicated otherwise explicitly or by context. As used herein, the use of the terms “promethium” and “Pm” refer to all isotopes and forms of promethium unless indicated otherwise explicitly or by context. As used herein, the use of the terms “samarium” and “Sm” refer to all isotopes and forms of samarium unless indicated otherwise explicitly or by context. As used herein, the use of the terms “europium” and “Eu” refer to all isotopes and forms of europium unless indicated otherwise explicitly or by context. As used herein, the use of the terms “gadolinium” and “Gd” refer to all isotopes and forms of gadolinium unless indicated otherwise explicitly or by context. As used herein, the use of the terms “terbium” and “Tb” refer to all isotopes and forms of terbium unless indicated otherwise explicitly or by context. As used herein, the use of the terms “dysprosium” and “Dy” refer to all isotopes and forms of dysprosium unless indicated otherwise explicitly or by context. As used herein, the use of the terms “holmium” and “Ho” refer to all isotopes and forms of holmium unless indicated otherwise explicitly or by context. As used herein, the use of the terms “erbium” and “Er” refer to all isotopes and forms of erbium unless indicated otherwise explicitly or by context. As used herein, the use of the terms “thulium” and “Tm” refer to all isotopes and forms of thulium unless indicated otherwise explicitly or by context. As used herein, the use of the terms “ytterbium” and “Yb” refer to all isotopes and forms of ytterbium unless indicated otherwise explicitly or by context. As used herein, the use of the terms “lutetium” and “Lu” refer to all isotopes and forms of lutetium unless indicated otherwise explicitly or by context. As used herein, the use of the terms “calcium” and “Ca” refer to all isotopes and forms of calcium unless indicated otherwise explicitly or by context. As used herein, the use of the terms “strontium” and “Sr” refer to all isotopes and forms of strontium unless indicated otherwise explicitly or by context. As used herein, the use of the terms “cesium” and “Cs” refer to all isotopes and forms of cesium unless indicated otherwise explicitly or by context. As used herein, the use of the terms “barium” and “Bo” refer to all isotopes and forms of barium unless indicated otherwise explicitly or by context.

As used herein, the terms “shear module,” “shear pump,” and “high shear device” are used interchangeably. As used herein, the term “psi” means “pounds per square inch,” the term “hz” means “hertz” and is a common unit of frequency, the term “rpm” means “revolutions per minute.” The terms “reactor,” “stirring reactor,” and “mixing reactor” are used interchangeably throughout the disclosure.

### DETAILED DESCRIPTION

I. Overview.

Herein disclosed are a system and method of breaking bonds between atomic and/or subatomic particles and/or creating new bonds between atomic and/or subatomic particles. More specifically, in one embodiment, herein disclosed are a system and method for removing subatomic particles from the nucleus of atoms. Even more specifically, in one embodiment, herein disclosed are a system and method of converting helium-4 into helium-3.

Although in one embodiment the process is described herein with reference to creating helium-3 from helium-4, those skilled in the art will recognize that the systems and methods disclosed herein may be applied to other nuclei as well for converting one isotope or element into a different isotope or element (e.g., lithium-7 to lithium-6, and helium-4 to tritium).

The system and method disclosed relies on generating high pressures and temperatures using a shear pump in order to generate energies sufficient to break and create bonds between atomic and/or subatomic particles. In one embodiment the energy is sufficient to remove a neutron from a helium-4 nucleus to produce helium-3. In embodiments, helium and hydrogen are combined (e.g. dissolved) in ammonium hydroxide to provide a solution. In embodiments, the solution of helium, hydrogen and ammonium hydroxide further comprises hydrazine, silver powder or both that may also be suspended and/or dissolved in the solution. Without wishing to be limited by theory, the hydrazine may act as an oxygen scavenger preventing or minimizing interaction of free oxygen released by the pressure of the shear pump with the hydrogen. The silver powder may comprise silver particles having an average size in the range of from about 2 to about 8 microns. The silver powder may enable transfer of energy from the rotor(s) of the shear module to the nuclei (e.g., to the hydrogen and helium nuclei), resulting in highly localized areas of extremely high pressure and temperature sufficient to promote nucleon-nucleon interactions. Through various different reactions, a hydrogen-1 nucleus (i.e. a proton) effectively removes a neutron from a helium-4 nucleus thereby resulting in helium-3 and byproducts.

Although the process is described herein with reference to helium as the element, silver powder as an agent to transfer the mechanical energy from the shear module to the nuclei, and ammonium hydroxide as solvent, those of ordinary skill in the art will recognize that, depending on the embodiment, other elements may be transformed, other materials such as, without limitation, pure inorganic materials, including metals, metal oxides, and ceramics, and/or other solvents, such as, without limitation, synthetic oil, motor oil, paraffinic oil, and soy oil may be utilized. In embodiments, no solid, such as metal particles, is needed to effect the transformation. As long as the shear is sufficient to effect nuclear reaction, solid particles may be absent. The incorporation of solid particles may enhance the extent or rate of the interaction, in embodiments. In embodiments, for example, an inorganic material is selected from the group consisting of nickel, aluminum, titanium, and combinations thereof. Numerous solvents may be utilized. In embodiments, the element to be transformed, hydrogen, and/or the mechanical transfer agent may be dissolved in the solvent. In embodiments, the solvent comprises one or more component selected from water, oils, and ammonium hydroxide. In embodiments, the solvent is selected from oils, such as, but not limited to, soybean oils, motor oils, paraffinic oils, synthetic oils, lipids, and combinations thereof. The shear may be increased via the incorporation of a more viscous oil. Utilization of a more viscous oil as or as a component of the solvent may enable the utilization of a reduced amount or substantially no solid particulate material.

In some reactions, rather than removing a neutron from the helium-4 nucleus, a proton is removed resulting in tritium and a free proton which may react with other helium-4 nuclei. Although tritium is radioactive, it is relatively harmless to humans unless ingested or inhaled. Furthermore, tritium decay into helium-3 may increase the ultimate yield of helium-3 produced via the disclosed system and process.

The herein disclosed system and process of converting helium-4 to helium-3 do not appear to produce excess high energy free neutrons. Consequently, since the apparatus and devices utilized are not rendered radioactive by bombardment of free neutrons, the disclosed process is a relatively safe one for the production of helium-3.

II. System for Conversion of Helium-4 into Helium-3.

The helium-3 generation system of this disclosure comprises at least one stirred reactor, one shear pump (also referred to as a high shear device or shear module), a liquid feed pump, a gas compressor, an accumulator pulsation dampener, and a cold trap. The system may further comprise one or more pumps in addition to those described below. The helium-3 generation system may further comprise one or more flow control valves. The system may be in electronic communication with a control system for monitoring and controlling flow into and out of the various components.

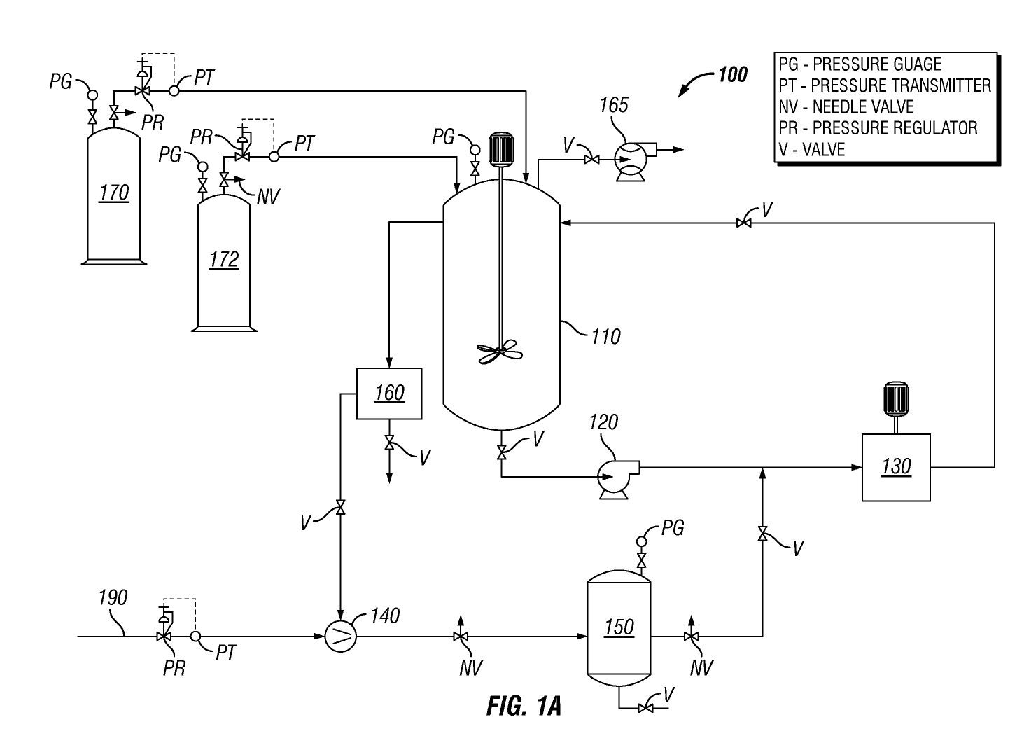

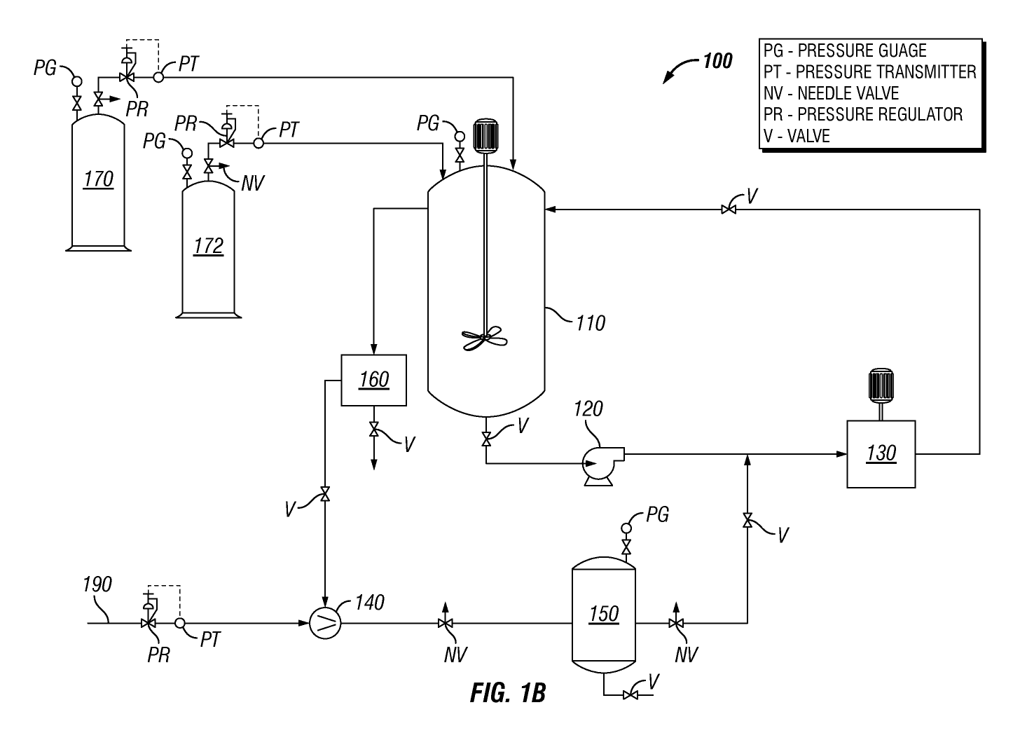

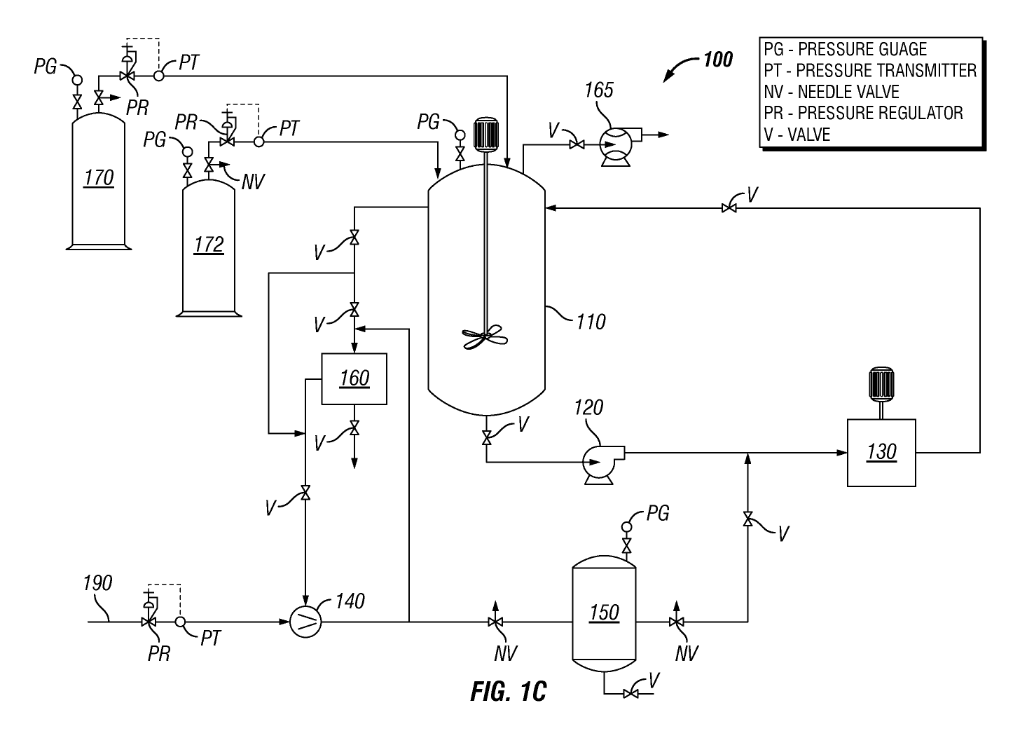

A system for helium-3 generation according to this disclosure will now be described with reference to FIGS. 1A-1C. FIGS. 1A-1C are schematics of a helium-3 generation system 100 according to an embodiment of this disclosure. FIG. 1A is a schematic of the system 100 during startup mode. FIG. 1B is a schematic of the system during run mode. FIG. 1C is a schematic of the system during vacuum mode. Helium-3 generation system 100 comprises a stirred reactor 110, a liquid feed pump 120, a shear pump 130, a gas compressor 140, an accumulator pulsation dampener 150, a separation unit 160, and a vacuum pump 165. System 100 also comprises a hydrogen source 170 and a helium source 172. In this embodiment, the separation unit 160 is a cold trap. However, in other embodiments, other separation units may be employed to separate the helium from the solvent. For example, in embodiments, separation unit 160 is selected from the group consisting of distillation columns and cryogenic fractionators.

In run mode, as depicted in FIG. 1B, hydrogen from hydrogen source 170 and helium from helium source 172 are combined (may be dissolved) in a solvent, such as, for example, ammonium hydroxide solution in stirring reactor 110. The helium from helium source 172 contains primarily helium-4, but may contain trace amounts of helium-3 in the proportion that helium-3 occurs naturally. Free oxygen degrades the generation of helium-3 by, for example, combining with hydrogen to produce water and decreasing the amount of hydrogen available for nuclear processes of converting helium-4 to helium-3. Thus, in embodiments, an oxygen scavenger is also mixed with the ammonium hydroxide solution. Any suitable oxygen scavenger known in the art may be utilized. In embodiments, the oxygen scavenger comprises hydrazine. The oxygen scavenger may serve to remove or reduce free oxygen that may be released as the mixture is processed by shear module 130 and thereby prevent or minimize interaction of oxygen with the hydrogen reactant. Small particles of inorganic material such as pure metal are also introduced into the mixture and become suspended therein. In embodiments, the mechanical transfer agent utilized dissolves in the solvent. In embodiments, hydrogen may not be dissolved in the solvent, but may be sheared within shear module 130. Desirably, the hydrogen and/or the mechanical energy transfer agent is dissolved and/or dissolves in the solvent (e.g. in water, oil, and/or other fluid). In embodiments, the metal particle is in the range of from about 2 microns to about 8 microns. In embodiments, the metal a pure metal. In embodiments, the metal comprises, consists essentially of, or consists of silver powder. The metal particles may comprise one or more metals selected from the group consisting of nickel, aluminum, and titanium. In embodiments, the silver powder is replaced with one or more other metal, metal oxide, and/or ceramic. In an embodiment, stirring reactor 110 operates at a reactor agitation of 600 RPM in order to mix the various components of the mixture. It is, however, primarily the shear module 130 that provides intimate mixing of the gas and liquid feed streams. The mixture is pumped by feed pump 120 from an outlet of the stirring reactor 110 to an inlet of the shear module 130. The shear module contains rotors and stators separated by a shear gap. In embodiments, the shear gap is greater than about 10 microns. In embodiments, the shear gap is less than or equal to about 250 microns. In embodiments, the shear gap is in the range of from about 10 microns to about 250 microns. In embodiments, the shear gap is on the order of about 250 microns. In embodiments, shear module 130 operates at about 7500 rpm. The high speed of the rotors and the small distance (i.e. the small shear gap) between each rotor and complementarily-shaped stator coupled with the presence of the metal particles result in a transfer of energy from the shear module to the elements being processed (e.g., to the hydrogen and helium). Without wishing to be limited by theory, it is believed that the pressures and temperatures in highly localized areas around groups of nuclei (e.g., hydrogen and helium nuclei) can become extremely high for a short duration, thus enabling nuclear interactions to take place between the nuclei (e.g., between hydrogen and helium-4 nuclei) and ultimately resulting in the conversion (e.g., conversion of at least a portion of helium-4 reactant into helium-3). The mixture exits shear module 130 through an outlet coupled to a recycle inlet on stirring reactor 110.

Air from an air supply 190 is the power source for a gas compressor 140 that feeds the compressed gas into an inlet of pulsation damper 150. Pulsation damper 150 ensures that a continuous flow of mixture is provided to shear module 130.

An outlet located at or near the top of stirring reactor 110 where headspace gases are located is fluidly coupled to an inlet of a cold trap 160. Cold trap 160 serves to condense and prevent liquid from entering gas compressor 140. Cold trap 160 comprises a sampling outlet to remove gas from system 100. The removed gas includes the helium-3 that has been generated by conversion of helium-4. Cold trap 160 also comprises an outlet that is fluidly coupled to an inlet of gas compressor 140, whereby material can be recycled through shear module 130.

Prior to run mode, system 100 may be operated in startup mode, as depicted in FIG. 1A, in order to remove impurities from the system. In startup mode, the solvent, such as ammonium hydroxide solution, is added to reactor 110 and reactor 110 is purged once or a plurality of times (e.g., twice) with hydrogen from hydrogen source 170 and once or a plurality of times (e.g., twice) with helium from helium source 172. A vacuum pump 165 draws a vacuum (e.g., a vacuum of 60 mm) on reactor 110 and subsequently a mixture of reactants (e.g., 50% hydrogen and 50% helium) is added to reactor 110 via first reactant (e.g., hydrogen) source 170 and second reactant (e.g., helium) source 172.

Once the system 100 has been purged with reactants (e.g., hydrogen and helium), the system 100 is set to run mode as depicted in FIG. 1B and described further hereinbelow. In run mode, vacuum pump 165 shown in FIG. 1A may be isolated and not used. Upon completion of run mode, the system is set to vacuum mode as depicted in FIG. 1C. The gas from the headspace from the stirring reactor 110 is vacuumed into cold trap 160, wherein liquid is condensed and dissolved gases released from the liquid. The gases can be extracted from a sampling point of cold trap 160. The gases released via vacuuming of liquid from the stirring reactor 110 comprise the helium-3 obtained via conversion of helium-4.

Helium-3 dissolved in the ammonium hydroxide can be stored indefinitely in this manner without loss of helium-3. In embodiments, the vessel is closed, gas is extracted from the therefrom and the ammonia condensed in an ice jacketed vessel. The remaining gas may be analyzed and/or the liquid condensate recycled to the reactor.

As mentioned hereinabove, although some embodiments are described herein with reference to obtaining helium-3 from helium-4, those skilled in the art will recognize that the methods and system described herein may be applied to other nuclei in order to obtain different isotopes or elements. Thus, the disclosure of the present disclosure is not limited to obtaining helium-3 from helium-4.

III. System for Converting One Isotope or Element into Another Isotope or Element.

The system for the conversion of atomic elements into other elements of this disclosure comprises at least one stirred reactor, one shear pump (also referred to as a high shear device or shear module), a liquid feed pump, a gas compressor, an accumulator pulsation dampener, and a cold trap. The system may further comprise one or more pumps in addition to those described below. The system may further comprise one or more flow control valves. The system may be in electronic communication with a control system for monitoring and controlling flow into and out of the various components.

As discussed further hereinbelow, one rare earth element may be converted to another via the disclosed system and method. In such embodiments, one rare earth element can act as proton or neutron donor with anther element acting as proton or neutron acceptor. Thus, for example, to produce an element E3 having Y protons, a first element E1 having Y-1 protons may be combined with a second element E2 having Y+n protons and transfer of protons from element E2 to element E1 can be used to convert element E1 into desired element E3. In embodiments, the proton/neutron donor and acceptor are the same element.

For example, in embodiments, the proton from a hydrogen atom may interact with the nucleus of a calcium atom to produce scandium by converting one neutron in the nucleus of the calcium atom into a proton. Similarly, a proton from a hydrogen atom may interact with the nucleus of a strontium atom to produce yttrium by converting a neutron in the nucleus of the strontium atom into a proton. In other embodiments, the proton from the hydrogen atom may interact with the nucleus of a barium atom to produce lanthanum. In embodiments, if the reactants and products are recycled through the system, the nucleus of the products, such as, for example, the nucleus of a lanthanum atom, may interact with a proton from a hydrogen atom to produce higher order rare earth elements, such as producing cerium from lanthanum. In addition to obtaining lanthanum from barium, if the process is allowed to continue for sufficient times, other rare earth elements other than lanthanum may be obtained from an initial source of barium. Thus, the process provides for the production of lanthanum, cerium, praseodymium, neodymium, promethium, samarium, europium, gadolinium, terbium, dysprosium, holmium, erbium, thulium, ytterbium, and lutetium.

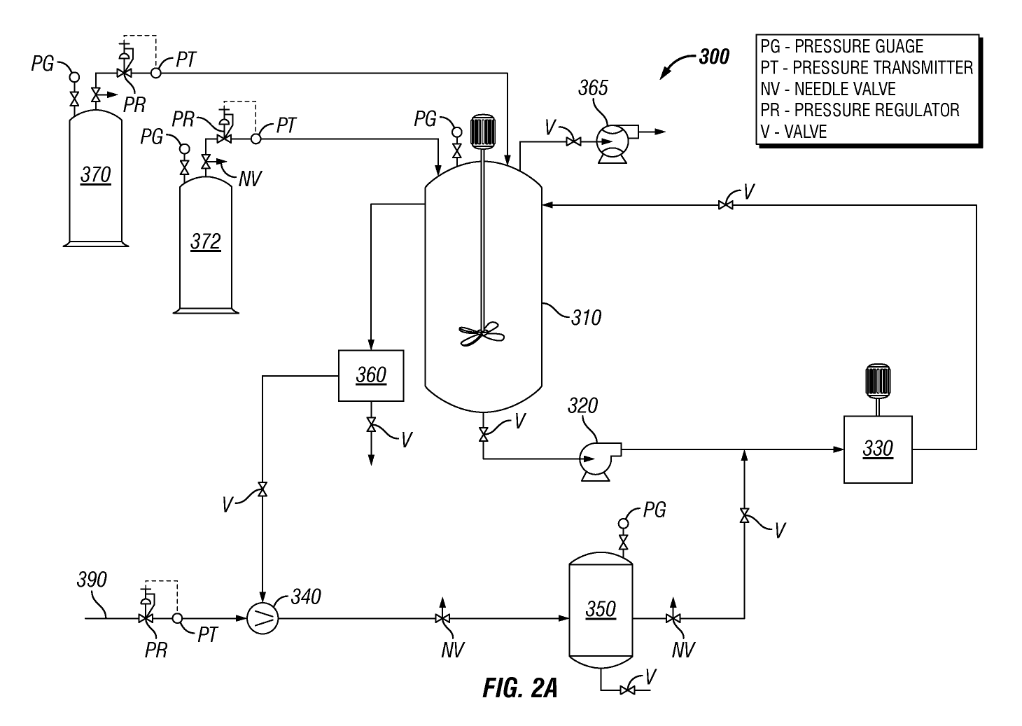

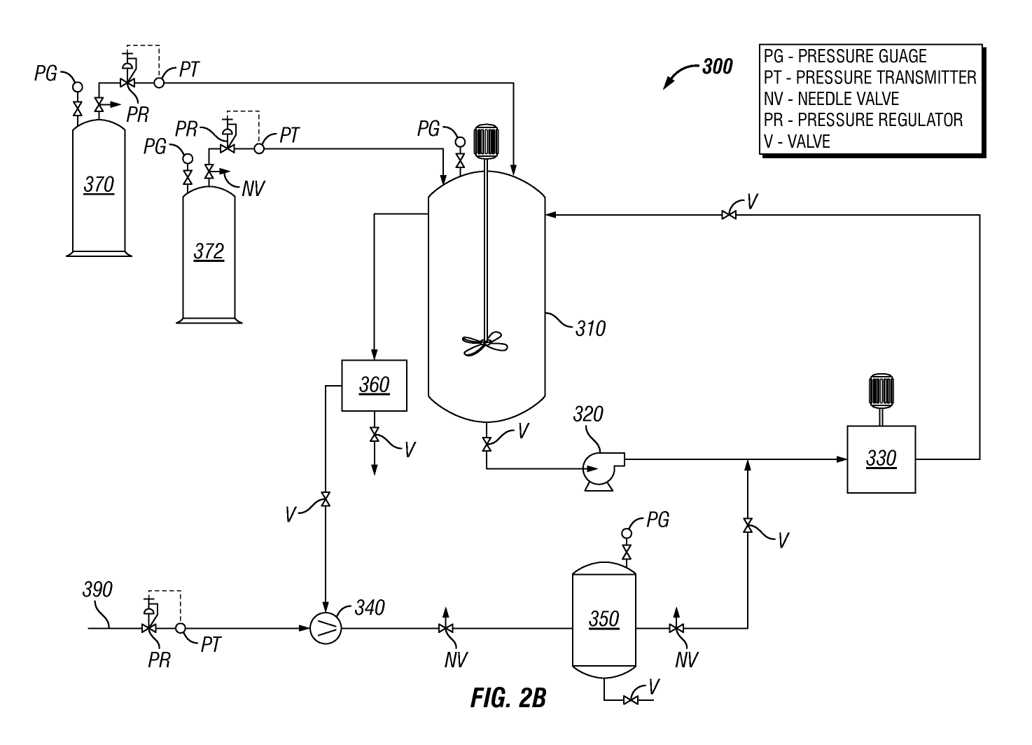

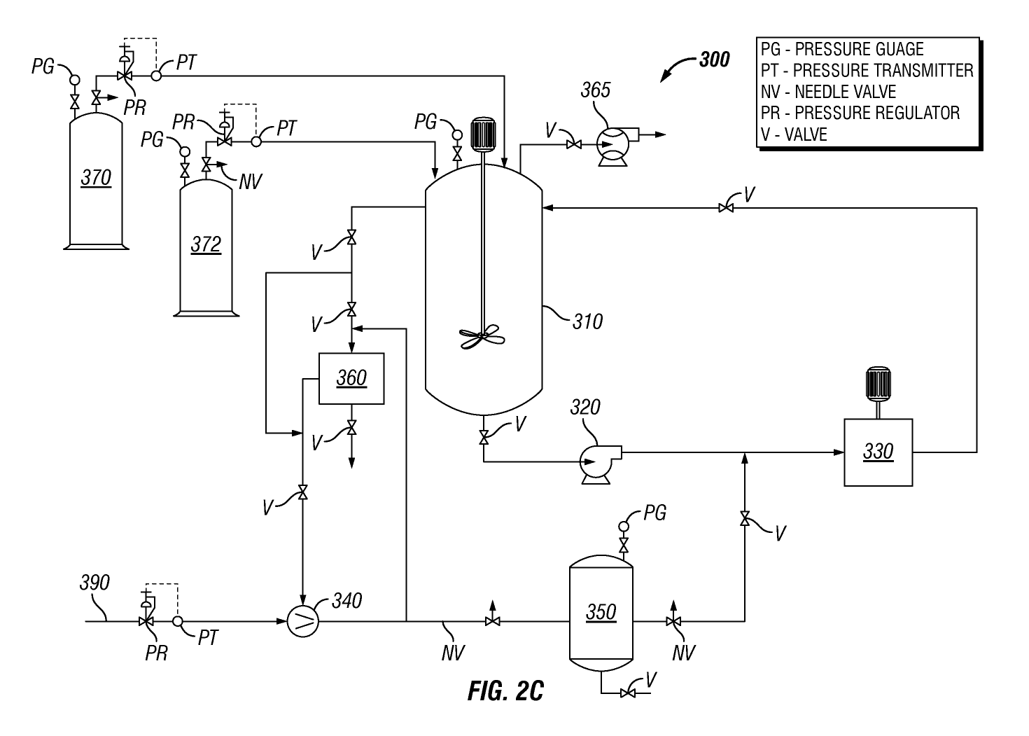

A system for converting elements according to this disclosure will now be described with reference to FIGS. 2A-2C. FIGS. 2A-2C are schematics of a system 300 for converting elements according to an embodiment of this disclosure. FIG. 2A is a schematic of the system 300 during startup mode. FIG. 2B is a schematic of the system during run mode. FIG. 2C is a schematic of the system during vacuum mode. Elemental conversion system 300 comprises a stirred reactor 310, a liquid feed pump 320, a shear pump 330, a gas compressor 340, an accumulator pulsation dampener 350, a separation unit 360, and a vacuum pump 365. System 300 also comprises a hydrogen source 370 and a reactant element source 372. The reactant element in reactant source 372 is in solution. In embodiments, the reactant element is one of calcium, strontium, and barium. In embodiments, the barium is in the form of barium hydroxide dissolved in water. In embodiments, the strontium is in the form of strontium carbonate dissolved in water. In this embodiment, the separation unit 360 is a cold trap. However, in embodiments, other methods of separating the reaction products from the solvent include distillation and cryogenic fractionation.

In run mode, as depicted in FIG. 2B, elements from element reactant source 372 are combined with (e.g. dissolved in) a solvent, such as, for example, water or ammonium hydroxide solution in stirring reactor 310. The reactant elements from source 372 should be in a soluble form before being introduced into the shear module 330. Small particles of inorganic material such as pure metal are also introduced into the mixture and become suspended in the mixture. In embodiments, the metal particle is in the range of from about 2 microns to about 8 microns. In embodiments, the metal is a pure metal. In embodiments, the metal comprises silver powder. In embodiments, the metal comprises one or more metal selected from the group consisting of nickel, aluminum, titanium, and combinations thereof. In embodiments, the silver powder is replaced with another metal(s), metal oxide(s), and/or ceramic(s). In an embodiment, stirring reactor 310 operates at a reactor agitation of 600 RPM in order to mix the various components of the mixture. It is, however, primarily the shear module 330 that provides intimate mixing of the gas and liquid feed streams. The mixture is pumped by feed pump 320 from an outlet of stirring reactor 310 to an inlet of shear module 330. The shear module contains at least one rotor and complementarily-shaped stator as described hereinabove. In embodiments, shear module 130 operates at about 7500 rpm. The high speed of the rotors and the small distance (shear gap) between each complementary rotor/stator set, coupled with the presence of the metal particles, result in a transfer of energy from the shear module to the element. The energy transfer from the rotors to the individual nuclei of the hydrogen and the reactant elements enables interactions between individual nuclei of the hydrogen and the reactant elements to convert some of the reactant element to different elements or to different isotopes of the reactant element. The mixture exits shear module 330 through an outlet coupled to a recycle inlet on stirring reactor 310.

Air from an air supply 390 is the power source for a gas compressor 340 that feeds compressed gas into an inlet of pulsation damper 350. Pulsation damper 350 is configured to maintain a continuous flow of mixture to shear module 330.

An outlet located at or near the top of stirring reactor 310 where headspace gases are located is fluidly coupled to an inlet of a cold trap 360. Cold trap 360 serves to condense and prevent and/or minimize the amount of liquid entering gas compressor 340. Cold trap 360 comprises a sampling outlet to remove gas from system 300. Cold trap 360 further comprises an outlet that is fluidly coupled to an inlet of gas compressor 340, whereby material may be recycled through shear module 330.

Prior to run mode, system 300 may be operated in startup mode, as depicted in FIG. 2A in order to remove impurities from the system. In startup mode, a solvent, such as ammonium hydroxide solution, is added to reactor 310 and reactor 310 is purged once or a plurality of times (e.g., twice) with a suitable gas from gas source 370. A vacuum pump 365 is operable to draw a vacuum (e.g., a 60 mm vacuum) on reactor 310 and subsequently gas is added into reactor 310 from first gas source 370 and/or second gas source 372.

Once the system 300 has been purged with gas, the system 300 is set to run mode as depicted in FIG. 2B and described above. In run mode, vacuum pump 365 shown in FIG. 2A may be isolated and not used. Upon completion of run mode, the system is set to vacuum mode as depicted in FIG. 2C. The gas from the headspace of stirring reactor 310 is vacuumed into cold trap 360, where liquid is condensed and dissolved gases released from the liquid. The gases can be extracted from a sampling point of cold trap 360. The gases released via vacuuming of liquid from the stirring reactor 110 comprise the converted element (i.e. the different element or isotope formed via the process).

As mentioned above, one rare earth element can be converted into another rare earth metal via embodiments of the disclosed system and method. In embodiments, a rare earth metal in liquid form (e.g., formed by mixing and dissolving a rare earth metal salt in a suitable carrier fluid or solvent, such as, but not limited to, ammonia, sulfuric acid or other fluid carrier in which the metal salt is soluble) is run through the high shear system disclosed herein, desirably in the presence of an inorganic solid (e.g., silver powder).

Although some embodiments are described herein with reference to obtaining rare earth elements from calcium, strontium, and barium, those skilled in the art will recognize that other reactant elements may be used and that different product elements may be obtained depending on the particular reactant elements chosen and the duration of the process. Also, although the process and system have been described using hydrogen, those skilled in the art will recognize that hydrogen may be replaced with other elements. Hydrogen was chosen to minimize the inhibiting effects of the electromagnetic forces that tend to repel nuclei from each other and thereby inhibit the nuclei from coming close enough to experience nuclear interactions therebetween.

It is also noted that the disclosed system and method can be adapted and utilized to clean drinking water that has been contaminated with radiation protons. In such embodiments, contaminated water is passed through the high shear device in the presence of hydrogen. One or a plurality of passes through the system can be utilized to convert the reactive protons and hydrogen to helium-3 and/or helium-4. Prior to consumption, chlorine may be added to the water. In such embodiments, small amounts of edible or inedible oil may be introduced into the high shear device/water prior to addition of hydrogen. The oil may serve as a carrier of hydrogen, helping break the hydrogen for fractions of a second (e.g., nanoseconds) and enabling the reaction to take place. By utilizing a hydrogen carrier, multiple passes through the high shear device may be performed. Hydrogen may be added substantially continuously until the oil/water is saturated with hydrogen gas. In cases where the gases are to be recovered and marketed and oxygen may be present (as in the case of water) an oxygen scavenger (such as hydrazine) may be utilized. In the cases of using non-oxygen containing hydrocarbons, no oxygen scavenger may be required.

In cases where helium-3 production is sought, a pure, non-oxidized metal, such as, but not limited to, substantially pure silver may be utilized as a transfer media to assist in the collision of gas molecules. In embodiments or applications in which helium-3 is not the desired end product, other transfer media may be utilized. An example of another transfer media includes, without limitation, contaminated sea water with oil emulsion. In this way the practice of this invention may serve to lessen or eliminate the presence of contaminated or hazardous dirty water by conversion of contaminants therein to a less hazardous or non-hazardous substance via conversion with hydrogen.

IV. High Shear Device for Conversion of One Element or Isotope into Another

A description of a High Shear Devices (HSD) suitable for use as shear module 130 in FIGS. 1A-1C to convert helium-4 into helium-3 or as shear module 330 in FIGS. 2A-2C to convert one isotope or element into another isotope or element is provided below.

An approximation of energy input into the fluid (kW/L/min) by an HSD can be made by measuring the motor energy (kW) and fluid output (L/min). In embodiments, the energy expenditure of a high shear device is greater than 1000 W/m³. In embodiments, the energy expenditure of a high shear device is in the range of from about 1000 W/m³ to about 7500 kW/m³. In embodiments, the energy expenditure is in the range of up to about 7500 W/m³. In still other embodiments, the energy expenditure of a high shear device is greater than 7500 W/m³. The shear rate generated in a high shear device may vary widely and depends on the diameter of the rotor, the speed of rotation of the rotor, and the size of the gap between the rotor and the stator. In embodiments, the shear rate generated by the high shear device is greater than about 100,000,000 s⁻¹. For example, in one embodiment, for a 12 inch diameter rotor operating at 15,000 rpm with a 1 micron gap, the shear rate is approximately 119,700,000 s⁻¹.

Tip speed is the velocity (m/sec) associated with the end of one or more revolving elements that is transmitting energy to the reactants. Tip speed, for a rotating element, is the circumferential distance traveled by the tip of the rotor per unit of time, and is generally defined by the equation V (m/sec)=π·D·n, where V is the tip speed, D is the diameter of the rotor, in meters, and n is the rotational speed of the rotor, in revolutions per second. Tip speed is thus a function of the rotor diameter and the rotation rate. Also, tip speed may be calculated by multiplying the circumferential distance transcribed by the rotor tip, 2πR, where R is the radius of the rotor (meters, for example) times the frequency of revolution (for example revolutions per minute, rpm).

For an embodiment of the disclosed high shear device, typical rotation rates are of the order 15,000 rpm and higher. Tip speeds depend on the size of the motor. In embodiments, typical tip speeds are in excess of 23 m/sec (4500 ft/min) and can exceed 40 m/sec (7900 ft/min). For the purpose of the present disclosure the term “high shear” refers to mechanical rotor-stator devices, such as mills or mixers, that are capable of tip speeds in excess of 5 m/sec (1000 ft/min) and require an external, mechanically-driven power device to drive energy into the stream of products to be reacted. A high shear device combines high tip speeds with a very small shear gap to produce significant shear on the material being processed. Accordingly, very high pressures and elevated temperatures are produced during operation. In further embodiments, the pressure is dependent on the viscosity of the solution, rotor tip speed, and shear gap. Furthermore, the pressures for localized areas may significantly exceed 1050 MPa for short periods of time. Additionally, these localized areas also experience an extreme rise in temperature for these short periods of time.

Without being limited to a particular theory for the conversion of one element or isotope into another, such as, for example, helium-4 to helium-3, it is thought that this localized extreme pressure and temperature may be a result of a high-pressure mechanically induced or hydrodynamic cavitation. It is thought that the localized temperature during these short periods of time may exceed 100,000K. The inertia of the collapsing bubble wall confines the energy, thereby confining the extreme temperatures to the highly localized area. Thus, for short periods of time in highly localized areas, pressures and temperatures are sufficient to result in, for example, nuclear interactions between hydrogen and helium-4 nuclei. Some of these interactions result in helium-4 being converted into helium-3. In other embodiments, the proton from a hydrogen atom may interact with the nucleus of a calcium atom to produce scandium by converting one neutron in the nucleus of the calcium atom into a proton. Similarly, a proton from a hydrogen atom may interact with the nucleus of a strontium atom to produce yttrium by converting a neutron in the nucleus of the strontium atom into a proton. In other embodiments, the proton from the hydrogen atom may interact with the nucleus of a barium atom to produce lanthanum. In embodiments, if the reactants and products are recycled through the system, the nucleus of the products, such as, for example, the nucleus of a lanthanum atom, may interact with a proton from a hydrogen atom to produce higher order rare earth elements, such as producing cerium from lanthanum. In addition to obtaining lanthanum from barium, if the process is allowed to continue for sufficient times, other rare earth elements other than lanthanum may be obtained from an initial source of barium. Thus, the process provides for the production of lanthanum, cerium, praseodymium, neodymium, promethium, samarium, europium, gadolinium, terbium, dysprosium, holmium, erbium, thulium, ytterbium, and lutetium.

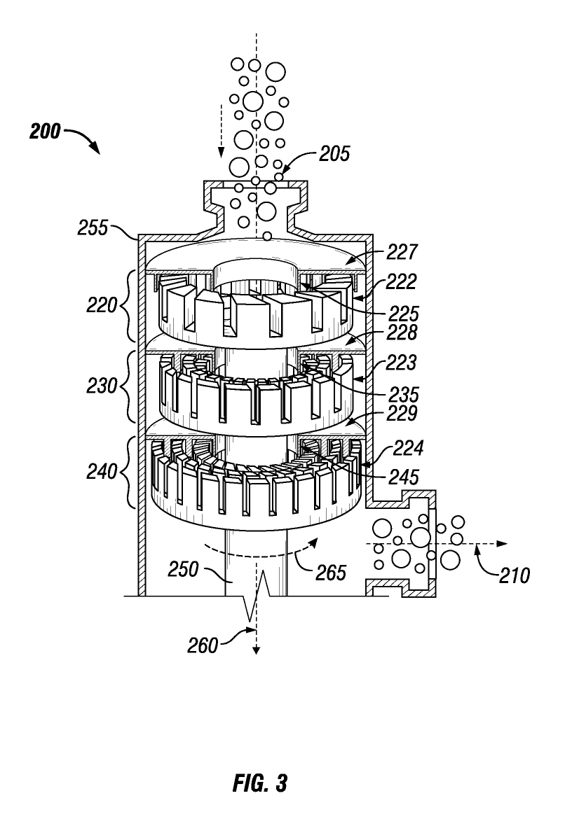

Referring now to FIG. 3, there is presented a schematic diagram of a high shear device 200. High shear device 200 comprises at least one rotor-stator combination. The rotor-stator combinations may also be known as generators 220, 230, 240 or stages without limitation. The high shear device 200 comprises at least two generators, and most preferably, the high shear device comprises at least three generators.

The first generator 220 comprises rotor 222 and stator 227. The second generator 230 comprises rotor 223, and stator 228; the third generator comprises rotor 224 and stator 229. For each generator 220, 230, 240 the rotor is rotatably driven by input 250. The generators 220, 230, 240 rotate about axis 260 in rotational direction 265. Stator 227 is fixably coupled to the high shear device wall 255.

The generators include gaps between the rotor and the stator. The first generator 220 comprises a first gap 225; the second generator 230 comprises a second gap 235; and the third generator 240 comprises a third gap 245. The gaps 225, 235, 245 may be between 1 and 250 microns wide. In certain instances, the gap 225 for the first generator 220 is greater than about the gap 235 for the second generator 230, which is greater than about the gap 245 for the third generator 240.

Additionally, the width of the gaps 225, 235, 245 may comprise a coarse, medium, fine, and super-fine characterization. Rotors 222, 223, and 224 and stators 227, 228, and 229 may be toothed designs. Each generator may comprise two or more sets of rotor-stator teeth, as known in the art. Rotors 222, 223, and 224 may comprise a number of rotor teeth circumferentially spaced about the circumference of each rotor. Stators 227, 228, and 229 may comprise a number of stator teeth circumferentially spaced about the circumference of each stator. In embodiments, the inner diameter of the rotor is about 11.8 cm. In embodiments, the outer diameter of the stator is about 15.4 cm. In further embodiments, the rotor and stator may have an outer diameter of about 60 mm for the rotor, and about 64 mm for the stator. Alternatively, the rotor and stator may have alternate diameters in order to alter the tip speed and shear pressures. In certain embodiments, each of three stages is operated with a super-fine generator, comprising a gap of less than or equal to approximately 250 microns. In other embodiments, one or more of the three generators 220, 230, and 240 (the generators may also be referred to herein as stages) is operated with a super-fine generator, comprising a gap of between about 1 to 250 microns. In embodiments, high shear device 200 comprises more than three stages or generators, for example, four stages or generators. In other embodiments, the high shear device 200 comprises less than the three generators 22, 230, and 240 depicted.

High shear device 200 is fed a reaction mixture comprising the feed stream 205. In embodiments, feed stream 205 comprises hydrogen, helium, and a solvent mixed with an oxygen scavenger and micron sized particles of a metal, which may be suspended in the mixture. In embodiments of the present disclosure, the solvent is an ammonium hydroxide solution and the oxygen scavenger is hydrazine. However, an oxygen scavenger is not required for all embodiments. Feed stream 205 is pumped through the generators 220, 230, 240, such that product stream 210 is formed. The product 210 contains the same mixture of chemicals as the feed stream 205 except that some of the original helium-4 has been converted into helium-3. In each generator, the rotors 222, 223, 224 rotate at high speed relative to the fixed stators 227, 228, 229. The rotation of the rotors pumps fluid, such as the feed stream 205, between the outer surface of the rotor 222 and the inner surface of the stator 227 creating a localized high shear condition. The gaps 225, 235, 245 generate high shear forces that process the feed stream 205. The high shear forces between the rotor and stator functions to process the feed stream 205 to create the product stream 210. In particular, the silver powder imparts the mechanical energy from the rotors 222, 223, and 224 and stators 227, 228, and 229 to the elements, such as, for example, hydrogen and helium nuclei. The rotor is set to rotate at a speed commensurate with the diameter of the rotor and the desired tip speed as described above.

Selection of the high shear device 200 is dependent on throughput requirements and desired particle or bubble size in the outlet dispersion 210. In certain instances, high shear device 200 comprises a DISPAX REACTOR® of IKA® Works, Inc. Wilmington, N.C. and APV North America, Inc. Wilmington, Mass. Model DR 2000/4, for example, comprises a belt drive, 4 M generator, PTFE sealing ring, inlet flange 1″ sanitary clamp, outlet flange ¾″ sanitary clamp, 2 HP power, output speed of 7900 rpm, flow capacity (water) approximately 300-700 l/h (depending on generator), a tip speed of from 9.4-41 m/s (about 1850 ft/min to about 8070 ft/min). Several alternative models are available having various inlet/outlet connections, horsepower, nominal tip speeds, output rpm, and nominal flow rate.

Without wishing to be limited to a particular theory, it is believed that the level or degree of high shear mixing is sufficient to produce localized high pressure and high temperatures that enable nuclear reactions to occur that would not otherwise be expected to occur. Localized conditions are believed to occur within the high shear device resulting in increased temperatures and pressures. The increase in pressures and temperatures within the high shear device are instantaneous and localized and quickly revert back to bulk or average system conditions once exiting the high shear device. In some cases, the localized pressures and temperatures are believed to be sufficient to overcome the coulomb barrier and allow for nucleon-nucleon interaction between the nuclei of different atoms. The mechanisms for the various reactions are not known. It is believed, however, that in the conversion of helium-4 to helium-3 embodiment, at least some of the reactions involve high energy impact of a proton upon a helium-4 nucleus resulting in a neutron being removed from the helium-4 nucleus with formation of a helium-3 nucleus. Products other than helium-3 may also be produced via the disclosed system and method. For example, tritium may be produced. However, because tritium ultimately decays into helium-3, production of this element is seen as beneficial. Because helium-4 is an extremely stable nucleus with a higher binding energy than helium-3, the process consumes energy rather than releases energy. Furthermore, because helium-4 is extremely stable, much of the helium-4 exits the high shear device 200 without being converted to helium-3. In experiments implementing embodiments of the present disclosure, however, increase in yields of helium-3 have been achieved such that the quantity of helium-3 is increased by 3%, 5%, 7%, 10%, 12%, 14% or more greater than prior to processing. Thus, the high shear mixing device of certain embodiments of the present system and methods is operated under what are believed to be conditions effective to result in the removal of a neutron from some helium-4 nuclei, thereby converting some helium-4 nuclei into helium-3 nuclei.

As noted hereinabove, in embodiments, the disclosed system is utilized to convert a first element into an isotope of the first element. Although not meant to be limited to the specific examples discussed in detail herein, it is envisioned that the disclosed system and method may be particularly useful for conversion or ‘transmutation’ of radioactive isotopes of an element (i.e. ‘radionuclides’ of an element) into non-radioactive isotopes of the element. For example, the disclosed system and method may be useful for treating contaminated fluid, such as, without limitation, water and/or sludge contaminated with one or more radionuclides, whereby at least a portion of the radionuclide(s) may be converted into a non-radioactive or less radioactive form of the element (e.g., wherein the radionuclide is converted into a naturally occurring, non-radioactive isotope of the element) via high shear contact with hydrogen. The high shear provides atomic hydrogen which may react with the element, as discussed hereinabove. Desirably, the contaminated fluid to be treated comprises oil. If not, oil may be added to the contaminated fluid prior to introduction into the high shear device. The oil may comprise recycled vegetable oil, motor oil, molten wax, etc. An oxygen scavenger, such as, but not limited to, hydrazine, may be added to the contaminated fluid prior to introduction into the high shear device.

In embodiments, a contaminated fluid containing one or more radionuclides of cesium and/or strontium is treated as disclosed herein to provide a treated fluid containing stable (or ‘more stable’) isotope(s) of the element(s). The ‘more stable’ isotope(s) may have a shorter half life than the radionuclide(s). The contaminated fluid may contain the first element and solid particles, such as, but not limited to, sand in water and/or oil.

In embodiments, the contaminated fluid comprises at least one radioactive isotope of strontium (i.e. strontium-89 and/or strontium-90), and at least a portion of the at least one radioactive isotope is converted to one or more non-radioactive strontium isotope (i.e. to strontium-84, strontium-86, strontium-87, and/or strontium-88). In embodiments, the radioactive isotope(s) of strontium are converted primarily to strontium-88.

In embodiments, the contaminated fluid comprises at least one radioactive isotope of cesium (i.e. cesium-129, cesium-131, cesium-132, cesium-134, cesium-135, cesium-136, and/or cesium-137), and at least a portion of the at least one radioactive isotope is converted to cesium-133. In embodiments, the contaminated fluid comprises at least one radioactive isotope of cesium selected from cesium-134, cesium-135, and cesium-137, and at least a portion of the at least one radioactive isotope is converted to cesium-133.

Upon reading this disclosure, one of skill in the art will appreciate the applicability of the disclosed system and method to the conversions of other elements/isotopes.

Example of Helium-4 to Helium-3 Process:

In a specific embodiment of the helium-4 to helium-3 process, the reaction contents comprise two (2) bottles of silver, 99.9% metal basis, 5-8 micron, 50 grams each; two (2) bottles of hydrazine, 98%, 100 grams each; two (2) bottles of silver, 99.9% metal basis, 2-3.5 microns, 50 grams each; and three (3) bottles of ammonium hydroxide solution, 2.5 liters each. The startup procedure for adding the reaction contents comprised adding the three (3) bottles of ammonium hydroxide to reactor 110. The system 100 was purged with hydrogen and helium twice for each with a pull vacuum on the reactor 110 of 60 mm. Once the helium and hydrogen purge of the reactor 110 was performed, hydrazine was added to the reactor 110 to eliminate oxygen. The silver powder was added into the reactor 110 after the hydrazine had been added thereto.

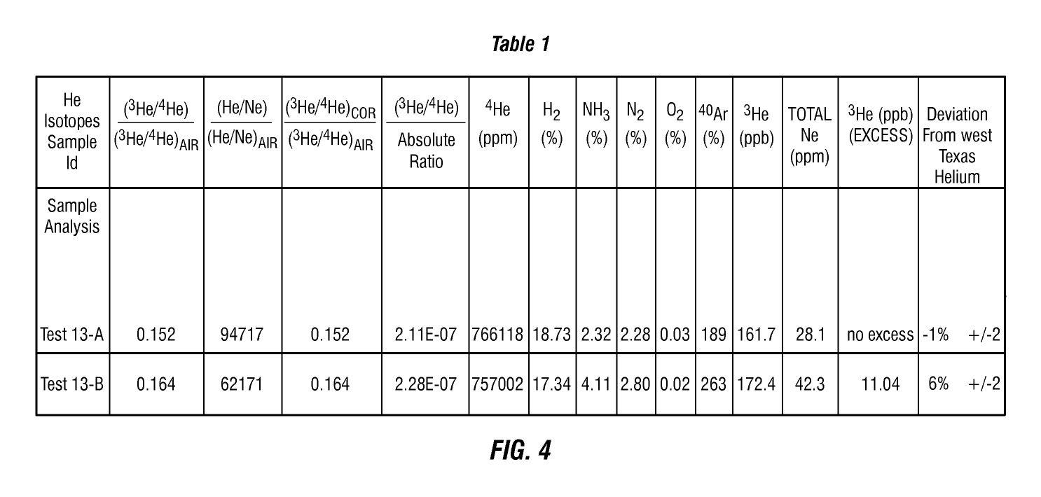

Once the startup procedure had been completed, hydrogen and helium from sources 170 and 172 were added into reactor 110 in a ratio of 50 volume or mole percent hydrogen and 50 volume or mole percent helium with 20-30 psi on the reactor. The agitation of reactor 110 was 600 rpm to maintain a uniform mix of the liquid and solid components and gases in reactor 110. Pump 120 pumped the mixture from reactor 110 to shear module 130. Shear module was operated at 7900 rpm. The fluid exited shear module 130 and returned to stirring reactor 110 and the process repeated numerous times over a seven hour period. Samples were pulled from cold trap 160 after run time and after vacuum distilling the reactor 110 liquid into the cold trap 160. Samples were analyzed according to the procedure outlined below and the results of the analysis are presented in the table illustrated in FIG. 4. The sample collected before reactor 110 was subjected to a vacuum is referred to as sample 13A and the sample collected after vacuum distilling the reactor 110 liquid into the cold trap 160 is referred to as sample 13B. Thus, sample 13A is pre-processed helium, i.e. helium prior to being subjected to interacting with the hydrogen through the shear device. Sample 13B is post-processed helium, i.e. helium after being subjected to interacting with the hydrogen through the shear device. As can be seen in FIG. 4, the sample 13B (post process helium sample) which contains the helium-3 converted from helium-4 contains significantly more helium-3 than does sample 13A (pre-processed helium sample).

Analytical Methods for Tritium and Helium

Air samples (0.5 cc air) are processed on a high vacuum line constructed of stainless steel and Corning-1724 glass to minimize helium diffusion. After removal of H₂O vapor and CO₂ at −90° C. and −95° C. respectively, the amount of non-condensable gas (e.g., He, Ne, Ar, O₂, N₂, and CH₄) was measured using a calibrated volume and a capacitance manometer. Gas ratios (N₂ N₂, Ar, CH₄) were analyzed on a Dycor Quadrupole mass spectrometer fitted with a variable leak valve. The results are combined with the capacitance manometer measurement to obtain gas concentrations (+/−2%). Prior to helium isotope analyses, N₂ and O₂ are removed by reaction with Zr—Al alloy (SAES-ST707), Ar and Ne are adsorbed on activated charcoal at 77 K and at 40 K, respectively. SAES-ST-101 Getters (one in the inlet line and 2 in the mass spectrometer) reduce the HD⁺ background to 1,000 ions/sec.

Helium isotope ratios and concentrations were analyzed on a VG 5400 Rare Gas Mass Spectrometer fitted with a Faraday cup (resolution of 200) and a Johnston electron multiplier (resolution of 600) for sequential analyses of the ⁴He (F-cup) and ³He (multiplier) beams. On the axial collector (resolution of 600)³He is completely separated from HD⁺ with a baseline separation of <2% of the HD⁺ peak. The contribution of HD⁺ to the ³He peak is <0.1 ion/sec at 1,000 ions/sec of HD⁺. For 2.0 μcc of He with an air ratio (sensitivity of 2×10⁻⁴ Amps/torr), the ³He signal averaged 2,500 ions/sec with a background signal of ˜15 cps, due to either scattered ⁴He ions or the formation of ⁴He ions at lower voltage potentials within the source of the mass spectrometer. All ³He/⁴He ratios are reported relative to the atmospheric ratio (R_{A}), using air helium as the absolute standard. Errors in the ³He/⁴He ratios result from the precision of the sample measurement (0.2%) and variation in the ratio measurement in air (0.2%) and give a total error of 0.3% at 2σ for the reported helium isotope value. Helium concentrations are derived from comparison of the total sample to a standard of known size. The value, as measured by peak height comparison, is accurate to 1% (2σ).

Tritium values are analyzed using the ³He “in-growth” technique. 150 g of water are degassed of all He on a high vacuum line and sealed in a 3″ O.D. 1724 glass ampoule for a period of 60 to 90 days. Glass ampoules had been baked at 250° C. in a helium-free nitrogen gas to minimize the solubility of helium in the glass. After sealing, the ampoules are stored at −20° C. to limit diffusion of helium into the bulb during sample storage. During this interval, ³He produced from the decay of tritium accumulates in the flask. Typical sample blanks are ˜10⁻⁹ cc of ⁴He and 10⁻¹⁵ cc of ³He. Blank corrections to ³He are made using the ⁴He content and assuming that the blank has the air ³He/⁴He ratio. The ³He content of the storage ampoule is measured on the VG 5400 using the above procedures and compared to the ³He content of air standard. Typical ³He signals for a sample containing 10 T.U. and stored for 90 days are ˜8×10⁵ atoms (±2%) and a blank of 3±1×10⁴ atoms of ³He. Errors in the reported tritium value are dependent on the amount of tritium and are 2% (2σ) at 10 T.U. Higher precision can be achieved with larger samples and longer storage times.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, and so forth). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The disclosures of all patents, patent applications, and publications cited herein are hereby incorporated by reference, to the extent they provide exemplary, procedural or other details supplementary to those set forth herein.

What is claimed is:

1. A system for converting a first substance into a second substance, the system comprising:
a mixing reactor configured to provide a reactant mixture comprising a first reactant, a second reactant, and a solvent; and
a high shear device fluidly connected to the mixing reactor, wherein the high shear device comprises:
at least one rotor/stator set comprising a rotor and a complementarily-shaped stator symmetrically positioned about an axis of rotation and separated by a shear gap, wherein the shear gap is in the range of from about 10 microns to about 250 microns; and
a motor configured for rotating the rotor about the axis of rotation, whereby energy can be transferred from the rotor to the reactants, thereby inducing reactions between the first reactant and the second reactant to form a product.

2. The system of claim 1, wherein the first reactant and the second reactant are substantially the same.

3. The system of claim 1, wherein the first reactant comprises primarily a soluble form of an element selected from the group consisting of calcium, strontium, and barium.

4. The system of claim 1, wherein first reactant comprises primarily hydrogen.

5. The system of claim 1, wherein the first reactant comprises primarily a first element, the second reactant comprises primarily a second element and the product comprises primarily a third element.

6. The system of claim 1, wherein the first reactant comprises primarily a first element, at least a portion of the second reactant is a first isotope of a second element, and the product comprises primarily a second isotope of the second element.

7. The system of claim 6, wherein the first element comprises primarily hydrogen, the first isotope of the second element is helium-4, and the second isotope of the second element is helium-3.

8. The system of claim 1, wherein the high shear device comprises at least three rotor/stator sets.

9. The system of claim 8, wherein the shear gap is different for at least two of the at least three rotor/stator sets.

10. The system of claim 8, wherein the shear gap is substantially the same for at least two of the at least three rotor/stator sets.

11. A system for converting helium-4 into helium-3, the system comprising:
a mixing reactor configured to provide a mixture of reactants, wherein the mixture comprises hydrogen, helium, and a solvent;
a high shear device fluidly connected to the mixing reactor, wherein the high shear device comprises:
at least one rotor/stator set comprising a rotor and a complementarily-shaped stator symmetrically positioned about an axis of rotation and separated by a shear gap, wherein the shear gap is in the range of from about 10 microns to about 250 microns;
a motor configured for rotating the rotor about the axis of rotation, whereby energy can be transferred from the rotor to the hydrogen and helium, thereby inducing localized areas of high pressure and high temperature promoting the interaction of hydrogen and helium nuclei such that at least a portion of the helium-4 in the helium is converted to helium-3;
a feed inlet to receive the reactant mixture from the mixing reactor, the feed inlet fluidly connecting the high shear device with a first outlet of the mixing reactor; and
a first outlet fluidly connecting the high shear device with a recycle inlet of the mixing reactor to provide the mixing reactor with a product mixture comprising converted helium-3 dissolved in the solvent; and
a separation unit configured to remove at least a portion of the converted helium-3 from the solvent.

12. The system of claim 11 wherein the solvent comprises at least one component selected from the group consisting of ammonium hydroxide, water, and oils.

13. The system of claim 11 wherein the mixture further comprise an oxygen scavenger.

14. The system of claim 13 wherein the oxygen scavenger comprises hydrazine.

15. The system of claim 11 wherein the mixture further comprises at least one metal selected from the group consisting of silver, aluminum, nickel, and titanium.

16. The system of claim 11 wherein the mixture further comprises metal particles, and wherein the metal particles have an average size in the range of from about two microns to about eight microns.

17. The system of claim 11 wherein the motor is capable of providing a rotational frequency of the rotor of up to at least about 7,900 RPM.

18. The system of claim 11 wherein the mixing reactor is operable at a pressure in the range of from about 20 psi and about 30 psi.

19. The system of claim 11 wherein the mixture comprises hydrogen and the helium in a ratio molar ratio of about 1.

20. The system of claim 11 wherein the helium comprises primarily helium-4.
